(19) United States
(12) Patent Application Publication
(10) Pub. No.: US 2016/0104339 A1
(43) Pub. Date: Apr. 14, 2016

(54) SYSTEM AND METHOD FOR MAKING FOOD ITEMS

(71) Applicant: Kevin Saccone, JR., Norwood, MA (US)

(72) Inventor: Kevin Saccone, JR., Norwood, MA (US)

(21) Appl. No.: 14/880,333

(22) Filed: Oct. 12, 2015

Related U.S. Application Data
(60) Provisional application No. 62/062,376, filed on Oct. 10, 2014.

(51) Int. Cl. G07F 13/00; B26D 5/00; B26D 7/28

(52) U.S. Cl. CPC G07F 13/00; B26D 7/28; B26D 5/005

(57) ABSTRACT

A food preparation system is provided. The food preparation system includes a revolving slicer configured to slice a plurality of different food items. The revolving slicer comprises a rotating barrel having a number of chambers along its length. A blade is positioned adjacent to a bottom face of the rotating barrel. When a chamber rotates past the blade, food within it may be sliced by the blade.

### BACKGROUND OF THE INVENTION

1. Field of the Invention

The present invention relates generally to food preparation. More particularly the present invention relates to a system and method that may automatically make a plurality of different food items with different ingredients based on an input.

2. Description of Related Art

Preparation of sandwiches, burritos, pizzas and other food items at a restaurant or shop is performed millions of times a day across the world. This preparation of these food items is a time and labor intensive activity. The process requires restaurant owners to hire and manage many workers. Also, wait times during the food preparation process, especially at so called “fast” food restaurants can leave the customers bored, frustrated, and disengaged. A number of experience enhancements have been attempted however none overcome the problem of engaging the customer in the production process. Similarly, fully or partially automated systems for food product production are not used in the industry.

Therefore, what is needed is a food preparation system that may quickly, and automatically produce a food item based on a customer's custom or standardized order.

### SUMMARY OF THE INVENTION

The subject matter of this application may involve, in some cases, interrelated products, alternative solutions to a particular problem, and/or a plurality of different uses of a single system or article.

The present invention may serve to replace human labor and interaction in a traditional food shop where customers typically move alongside their food item and verbally instruct the one preparing the food as to which ingredients they want on their food item.

The present invention is an automated food preparation system. The food preparation system of the invention uses a computerized system (including a computer memory, processor, input, and an optional display, among others) to send commands to control and operate machinery designed to disperse ingredients. These ingredients may be dispersed onto a form of bread, or into a salad bowl, for example, as the bread or salad bowl moves along an assembly line. It is also possible that the machinery itself moves while the food item being prepared remains stationary.

The computer may receive production commands input which it may then use to provide a signal or signals to direct the machinery for the selective and controlled slicing by the food preparation system. These inputs may be received and processed in any manner. In one embodiment, the computerized system could receive input at the point of sale when a complete order is taken or entered. In this embodiment, the computerized system may be provided with all the necessary inputs to fulfill the order.

In another embodiment, the computerized system may receive input throughout the process of forming the food item. For example, input may be provided incrementally into a user input as customers move alongside their food item in the assembly line and choose which ingredients they want dispersed onto their food item as they watch it being made (although watching is not required). This embodiment may require a novel embodiment which is an integrated touch screen or substitutable input device that gives customers or employees the ability to choose which ingredients to mechanically disperse onto their food item from the machinery. This input device may be a digital touch screen, push buttons, or similar devices which may show the available options at each station and give customers the ability to choose which ingredients they want on their food item. The input may then be received by the computerized system, and a signal(s) sent to the equipment to instruct it to disperse the selected ingredients onto their food item. While the integrated touch screen (or other input device) will not be necessary in all applications of the invention, it may provide an interactive experience for customers which may be valuable to distract and engage customers while they are waiting for their food.

The first aspect of the food preparation system of the present invention is a Revolving Slicer. The revolving slicer is similar to a regular food slicer (such as a Bizerba SE-12) in the sense that the blade is round and powered by an electrical motor to spin on a fixed axis. However, rather than having items placed on a carriage which moves back and forth over the blade to be sliced, the revolving slicer of the present invention holds multiple ingredients in separate chambers within a revolving barrel apparatus. This revolving barrel apparatus has the capability of pushing and/or retracting particular items towards and away from the blade to be sliced directly onto a sandwich or other food item, or onto a platform which places the ingredients on the food item. The revolving barrel apparatus may resemble that of a classic revolver handgun except it may be much larger in scale. In a particular embodiment, the revolving barrel apparatus may be sized to be between eighteen to thirty-six inches in diameter (but for certain applications larger and smaller diameters may be necessary). Chambers may extend within the rotating apparatus along its length, and in use are filled with food items to be sliced.

In use, the revolving barrel apparatus may rotate food items over a spinning slicer blade and electronic controls (as input from the computerized system) may govern which food items within the chambers should be directed towards the blade to be sliced. Both the revolving barrel apparatus and the slicer blade may be powered by an electronic motor and it need not be the same motor powering each component. The primary function of the revolving slicer will be to take solid (unsliced) foods that get loaded into the chambers of the revolving barrel apparatus and slice them onto a sandwich or other food item based off of a customer's order. The revolving slicer may also be capable of further slicing some prepared foods, for instance slivered onions could be sliced into smaller pieces. The food within the chambers need not be whole for the revolving slicer to work.

The second aspect of this invention is a salsa distributor which is a piece of equipment positioned over an assembly line for dispersing salsas, relishes, liquids, chopped proteins, granular foods and other food items with semi-liquid characteristics. While this equipment is referred to as a “salsa distributor” herein, it should be understood that it need not be limited to salsa usage, and indeed may be used to distribute or dispense any number of liquid or flowable (such as granular items) food items. This salsa distributor may be controlled electronically with commands given either at point of sale or throughout the process via customer input as customers move with their food item in an assembly line. To explain how the machine may work for a point of sale application, a customer may place their order either with a store clerk or in an automated self-checkout style machine without any human interaction, the ordering software may store which ingredients are desired on each order and where that particular order is on the assembly line, allowing the salsa distributor to disperse a chosen ingredient onto the food item when it passes underneath the portion of the salsa distributor which contains the chosen ingredient(s).

The salsa distributor may have multiple compartments for each food item to disperse, and may have a governor at the bottom to control the flow of ingredient onto a food item. The salsa distributor may be contained within a larger refrigerated unit or a larger heated unit capable of holding food at safe temperatures. The food ingredients may be filled either by hand or by machine from the top and may utilize gravity, and or/pressure to release ingredients onto the assembly line. In some cases an agitator may be used to help facilitate the flow of ingredient, similar to an agitator used in a push powered grass seed dispenser, which has a rotating prong to stir the seed and help ensure that a steady flow of product reaches the governor at the bottom. Often times an assembly line will require both a heated and a refrigerated salsa distributor. For example, in a Mexican restaurant that has hot and cold ingredients compatible with the equipment. In the aforementioned example the ingredients which are to be served warm may be placed into their respective chambers in the heated salsa distributor and the ingredients that are to be served cold may be placed in their respective chambers in a refrigerated salsa distributor.

To illustrate this, a customer could order a burrito and as she passes the heated salsa distributor she may have the option of choosing between heated items such as brown rice or white rice, and chicken or steak via an integrated touch screen, all of these items may be held in a separate chamber within the larger salsa distributor and the software knows the location of each food item and the standard portion to be dispersed when given the command to do so. As she chooses each item it may be dispensed onto her tortilla (or bowl for a burrito bowl) to form the burrito. Further down the assembly line could be another refrigerated salsa dispenser where the same patron then chooses which cold toppings she wants on her burrito and gets to choose between several salsa types, sour cream, guacamole and etc. and the salsa dispenser places a controlled portion of the selected items onto her burrito. Note that she could also simply place her order at the point of sale and the machine may proceed to make her burrito. A similar embodiment may be used to make a pizza either before or after cooking the pizza.

Such a flexible, yet mechanized, manufacturing solution is currently not found in the food service industry where businesses typically rely on agile and adaptable human labor to deal with a high volume of special requests, variations and substitutions in orders. While mechanized food assembly lines do exist for mass production, they are only designed to make one particular item in large batches and require substantial effort or switching costs to modify the assembly line to make a new item. There is nothing that can satisfy the just in time manufacturing agility and adaptability of the present invention. The present invention may help restaurants and food service businesses reduce the cost of human labor, and the costs associated with human error such as order inaccuracies and portion controls by assembling food products such as sandwiches, wraps, burritos, and salads primarily by machine. It is important to note that an assembly line does not need to include all embodiments of this invention as the demand for certain equipment will vary for each restaurant and menu.

### BRIEF DESCRIPTION OF THE DRAWINGS

FIG. 1 is a view of an embodiment of the present invention.

FIG. 2 is a side view of two embodiments of the revolving slicer of the present invention.

FIG. 3 is a side view of two salsa distributor embodiments of the present invention.

FIG. 4 is a view of an embodiment of an assembly line utilizing two revolving slicers.

FIG. 5 shows several embodiments of structures that may propel foods through the revolving slicer chambers.

FIG. 6 shows another embodiment of a structure that may propel foods through the revolving slicer chamber.

FIG. 7 shows yet another embodiment of a structure that may propel foods through the revolving slicer chamber.

FIG. 8 provides an elevation view of a sandwich assembly line which utilizes three revolving slicers.

FIG. 9 shows an elevation view of another embodiment of the revolving slicer.

FIG. 10 shows an elevation view of another embodiment of the revolving slicer assembly line.

FIG. 11 shows a view of another embodiment of the revolving slicer.

FIG. 12 shows a view of yet another embodiment of the revolving slicer.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The present invention will yield huge rewards for food service businesses. It can alleviate the high costs of labor and free up the human labor from the mechanical tasks of producing food items which can be made with greater precision by machine. This will greatly reduce the costs of labor, and the costs of human error associated with labor such as order inaccuracies and lack of precise portion controls. Furthermore the present invention enables one to consume a fresher product. The nutritional profile and general freshness of a food item deteriorate more rapidly when they are pre-sliced because the cell walls can become damaged and more surface area is exposed to oxidation with pre-sliced ingredients. This will allow the human workers to perform the tasks that they are best suited to such as providing warm and friendly service, while the mechanized tasks of producing food will be taken over by machine. It should be understood that not all of the components of this invention need to be used together, but in some cases they will be. Also the assembly lines utilizing the integrated touch screen, revolving slicer, and salsa distributor may also use existing machinery such as bagging/wrapping stations, conveyor toasters and etc. which can be tailored for each specific menu and application.

The food preparation system contemplated herein may include one or both of a revolving slicer, and a salsa dispenser as discussed in detail below. As used herein, the term “food preparation system” may be used to generally refer a food preparation system that utilizes one or both of the revolving slicer and/or salsa dispenser, depending on embodiment being discussed.

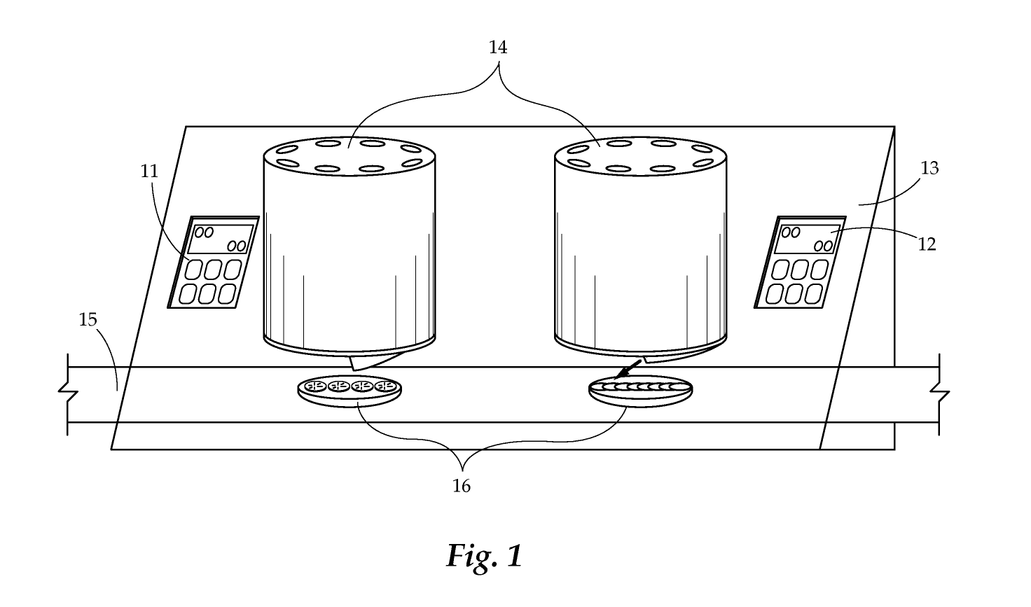

Referring now to the invention in more detail, in FIG. 1 a view of the integrated touch screen is provided. Two integrated touch screens, labeled 11 and 12 are shown along with a glass or transparent sneeze guard 13 (which is separating the food prep and customer area), two revolving slicers 14, a belt driven assembly line 15, and two sandwiches being made on the assembly line 16. A touch screen 11 is electronically connected to a revolving slicer via a computerized control system. Inputs into the touch screen 11 can direct which ingredients the slicer 14 distributes via customer input. In one embodiment, integrated touch screen 11 could have up to seven options to choose from (one for each slicer chamber being used). For instance, integrated touch screen 11 may be showing the produce ingredients and be in control of the revolving barrel of the revolving slicer stocked with produce. Therefore, the available options on the screen could show lettuce, tomato, cucumber, pickle, onion, bell pepper, and cherry peppers, or any other array of ingredients. A customer could then choose from the available array of ingredients simply by selecting their image on a graphical user interface shown on a touch screen. The touch screen input may be sent to the computerized controller which may provide an output to control operation of the food preparation system. The revolving slicer, salsa distributor or other machine connected to the integrated touch screen to distribute the selected ingredients onto the food item being made.

In one embodiment, a first revolving slicer 14 may be stocked with produce ingredients, while a second revolving slicer 14 may be stocked with proteins such as cold-cuts. This may keep cross contamination of vegetables and protein on the slicer blade from happening as the two may be separated.

While a touch screen 11, 12 may be a preferred embodiment of the integrated touch screen, it should be understood that any number of computerized input devices or systems may be used. For example, an existing point of sale system may be easily integrated with the revolving slicer and/or salsa dispenser system. This may allow a worker to receive the order and input it into the automated food preparation system. In another embodiment, a mobile app or internet input system may be used as at least part of a computerized control system which may automatically instruct the food preparation system to prepare the food item remotely through an internet or other online/networked connection. Further still, the integrated touch screen need not be operated by touch and could be substituted by a simple mechanical push button that sends an electronic signal; for such an application, images on a graphical user interface may be substituted for decals or static cling images of the ingredients positioned next to the push button, this could prove more durable in high volume establishments.

There are several variations on how to code a computerized controller such that one having skill in the art may be able to program the computerized aspect of the food preparation system. Likewise, parameters could be built into the code based on restaurant preferences; for instance so that customer's cannot choose more than three ingredients at each station. Additionally, sensors could be built into the machinery so that when a product is unavailable a graphical user interface will not allow customers to choose the unavailable ingredient. Additional sensors may be in communication with the computerized control system to track the status of the dispensed/sliced food. The computerized controller may then be configured to control the conveyor and other components based at least partially on an input from the sensor. A particular advantage of the integrated touch screen or other computerized integration in the food preparation system lies in the application of existing computer code and computer hardware to control machinery in a retail food establishment with direct input from the customers as they progress through a line.

It is noted that the integrated touch screen will not be a necessary component of many embodiments of this invention as some restaurants prefer to take an entire order at the point of sale, at which point all the needed inputs for the machinery may be gathered to fulfill the order and an integrated touch screen may not be necessary. In some embodiments, for restaurants that prefer to keep their customer's entertained and distracted with the impulsive ability to choose their ingredients as they progress through a line, it will be greatly appreciated and will replace human communications.

In another embodiment, it is not necessary to do away with the human communication aspect, for instance the graphical user interface of the integrated touch screen or other computerized input could be set up for employees to select the ingredients after a customer has requested them, although this is a bit redundant. Furthermore, abolishing the need for human conversation to occur over the food prep area is preferable to high risk populations such as the elderly, as microscopic saliva particles are misted over the food ingredients in a typical conversation between employee and customer.

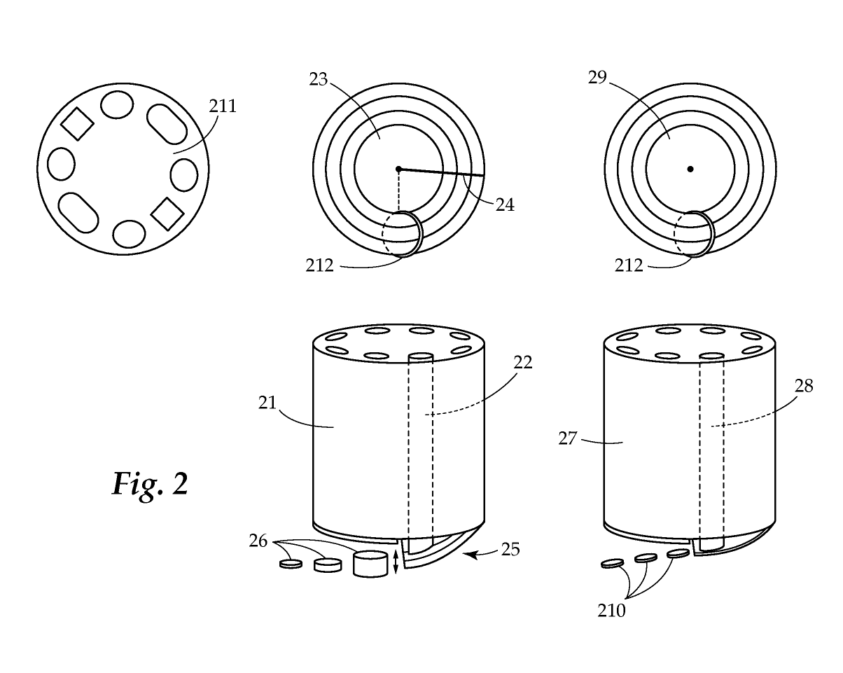

Turning to FIG. 2, two embodiments of the revolving slicer are shown. A revolving slicer with a variable slicing mechanism 21 and a revolving slicer with a fixed slicing mechanism 27. In both embodiments the blade 212 may be composed of a hard high quality steel or similar metal, plastic, ceramic, or other effective blade material. For each embodiment, the blade may be mounted to a motor to spin it on a fixed axis. The blade guards may be a primary difference between each slicer embodiment. The variable blade guard 23 and the fixed blade guard 29 are shown from an elevation view as they may appear without the revolving barrel apparatus housed on top of them. The dotted line depicted on the blade guards 23 and 29 depicts the portion of the blade 212 which may not be visible to the naked eye as that portion may be covered by the blade guard. The blade guards 23 and 29 are the bottommost portion of revolving slicers 21 and 27. Furthermore, a single slicing chamber of the barrel is depicted for both the variable and the fixed revolving slicer, labeled 22 and 28 respectively. The slicing chamber is shown loaded with a solid food product. Slicing chambers 22 and 28 are shown as being open on the top and the food product inside of them may be resting on (or slightly above) blade guards 23 and 29 respectively.

While the revolving slicing mechanisms are shown as having cylindrical barrels, it should be understood that the barrel may have any shape, such as an octagonal cross section, hub and spoke design, and the like.

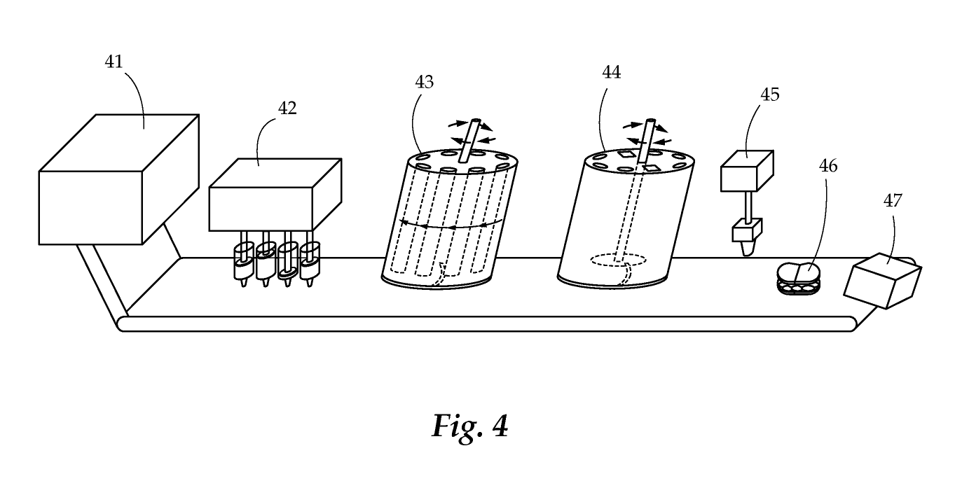

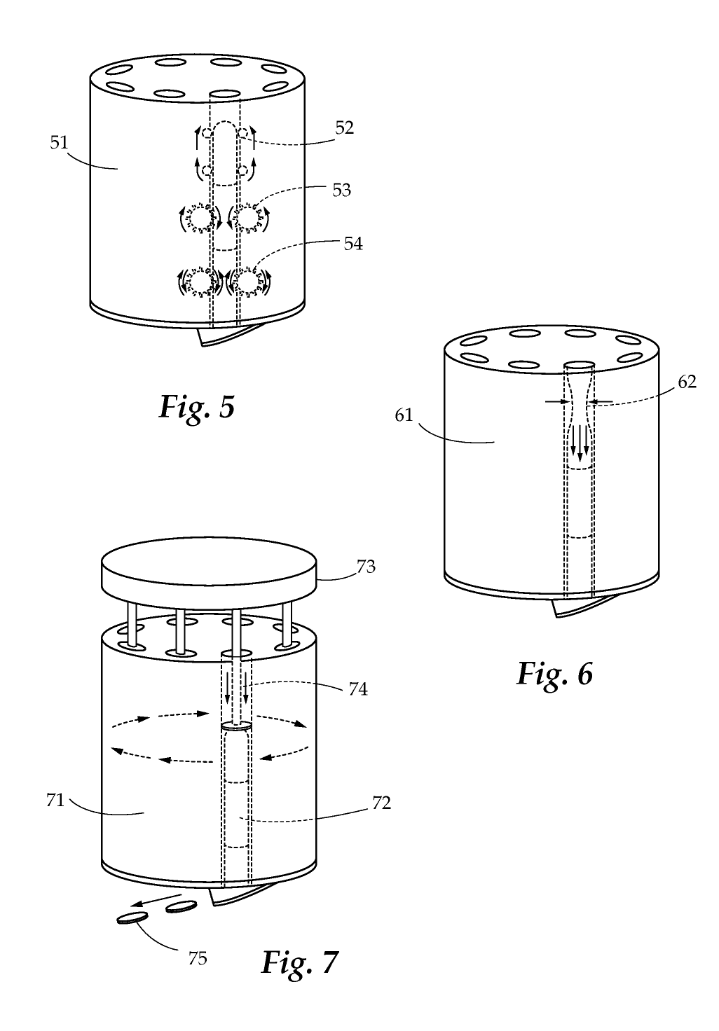

The slicing chambers depicted are essentially hollowed out cylinders (or other shape) of a round revolving apparatus which may be made of either a food grade metal such as aluminum or stainless steel, or a polymer. Slicing chambers 22 and 28 may be fitted with electronic and/or mechanical structures to propel food items towards (referred to herein as pistons) and/or away from (referred to herein as retracting structures) the blade which are given further detail in FIGS. 5, 6 and 7. The food item is able to come out of a bottom opening of the chamber on the bottom face of the barrel. Additionally, a break 24 is shown in the variable blade guard 23. The quadrant (roughly ¼ of the blade guard 23, shown as the lower and right hand piece) of the variable blade guard 23 that is in between the break 24 and the exposed blade section may be capable of lowering itself and raising itself evenly with a mechanical part to bring the section flush with blade so that nothing can be sliced. At the other end of the spectrum the break 24 could open the distance between the guard and the blade by a substantial distance. Note that in the drawings the adjustable section of the blade is shown as roughly ¼^{th} of the variable blade guard 23, yet it need not be this specific section of the variable blade guard 23. For example, the adjustable section could bisect the blade guard 23, making roughly one half of it the portion that lowers and the revolving slicer may still have functionality. In most applications, the needed range of distance between the exposed blade and the adjustable piece of the blade guard 23 may likely be between 1/32^{nd} to ¼ of an inch gap between the blade guard's adjustable section and the exposed blade edge. The break between the fixed and variable portion of the variable blade guard 23 depicted as 24 could be either hinged to the rest of the blade guard 23, or it could be separated so that the entire quadrant is capable of lowering and raising itself.

Several different mechanical devices could be used to raise and lower the quadrant such as a system of hydraulic pistons and arms, simple gears, and or levers controlled electronically. Slices of a food product cut at varying thickness are depicted as 26 whereas they are cut by the revolving slicer 21 with a variable blade guard; in contrast, food products of a uniform thickness are depicted as 210, shown being cut by a revolving slicer 27 with a fixed blade guard. An elevation view of a revolving apparatus with seven chambers is shown as 211 and may be compatible with both revolving slicer barrels 21 and 27.

There may be two main methods to adjusting the thickness of the variable blade guard 23 while the revolving chamber is in motion. A first method may be to lower the adjustable portion to the desired thickness and simultaneously push the chosen food items to rest on the lowered portion of the blade guard 23. The food item is then sliced by the blade 212 as the revolving slicer chamber passes over the blade 212. A second method may involve keeping the adjustable piece of the variable blade guard 23 held flush with the exposed blade edge via a spring (or multiple springs for balance). Hence food may not be sliced if it passes by unless downwards pressure that exceeds the upward force of the spring was applied. Then as the desired food item in a slicer chamber approaches the blade or adjustable quadrant, varying amounts of pressure directed towards the adjustable platform could be applied to the food item and thickness of the slice could be determined based on the amount of pressure applied.

To give further detail on the fixed blade guard 9 in FIG. 2, everything is identical to variable blade guard 3 except there is no break 24 in the guard and it may be one single piece with a slope engineered into it so that there is a predetermined gap between the exposed portion of the blade 212 and the bottom of the guard where it meets the blade. For instance a fixed gap of ¼″ may be workable for slicing most produce and could be used for a revolving slicer designated for slicing produce ingredients only. While this limits the range and flexibility of the revolving slicer, it should be noted that the food items in slicing chambers can still be propelled with a varying amount of force and hence a small degree of variation in the thickness of ingredients can be achieved with a fixed blade guard 29. With a fixed blade guard such as 9, the slicer chambers may need to be equipped with the ability to retract food upwards, or prevent them from going downwards via a mechanical function. In one embodiment a spiked wheel with an adjustable drag built into it so that the food will not fall towards the blade from the gravitational force, but rather it will only move downwards when the downward force overcomes the drag of the spiked wheel. Other existing alternatives to prevent the food from moving downwards are also available.

In use, regardless of if a fixed or variable blade guard is used, there are a number of various modes of operation to allow for multiple slices from a single slicing chamber to be dispensed onto the food item. In one embodiment, the revolving barrel may rotate multiple times, making a pass over the slicer blade for each slice of the food item in the particular chamber. Thus for three slices of a meat, the chamber of the barrel with the meat will rotate such that the chamber passes over the blade three times. In a particular embodiment, the blade and barrel may continually spin, and their slicing may be controlled by internal components that expose the food item within a particular chamber to the slicer on command. In another embodiment, the barrel may be able to move in two rotational directions, such that the barrel can pass over the slicer multiple times without making a full revolution. In still another embodiment, the slicer blade may be movable in a controlled manner by a mechanism in order to make multiple slices of the food within the chamber.

In further detail, still referring to the invention of FIG. 2, each slicer may be applicable for different uses and could be made so that the blade guards are interchangeable between units, offering flexibility should purchasers of the invention change their menu or etc. Essentially, a round blade 212 will be powered to spin by an electrical or equivalent motor. The spinning blade will be able to cut the food items as they are brought to it by the revolving slicer apparatus 21, 27 that may be housed on top of the blade 212 and the blade guards 23 or 29. Note that only a small portion of the blade 212 is exposed, which will be sufficient to cut through food items. The blade guards 23 and 29 may be stationary and may not rotate with the revolving apparatus which rests on top of them on a bearing so that the revolving apparatus can spin. This may allow individual slicing chambers to pass the blade 212. For example, a ball bearing washer, or a similar low friction device may be used to maintain proper spacing between the revolving slicer barrel 21, 27 and blade guard 23, 29 Typically, there will be very little distance between the blade guard 23 and 29 and the revolving apparatus which is spinning above. Typically less than ¼″ of spacing will be required between the two. In many instances the food items inside the chambers of the revolving apparatus will be resting on the blade guard 23, 29 as the revolving apparatus spins. A motor may power the revolving apparatus to spin either continuously or at will. In a specific embodiment, while the revolving apparatus may be spinning, a food product is propelled towards the blade at the discretion of a command given via the computer controller.

The food can be propelled downwards either by gravity or by any structure capable of urging it downwards. Non-limiting examples of such apparatuses are depicted in FIGS. 5, 6 and 7. The computer controller also may keep track of which food item is positioned underneath the blade of the revolving slicers 21 and 22 to ensure that food items cast from the slicers (such as 26 and 210) land where they should. Additionally the computerized controller may direct the machinery to distribute (push towards the blade and slice) the items stored in slicing chambers akin to those represented by 22 and 28 according to the customer's order. The variable blade guard 23 will have the ability to adjust thickness between each item being sliced or less frequently if such precision is not required. The edge of the blade 212 will be positioned to roughly bisect the revolving slicer chambers. Food items loaded in slicer chambers similar to 22 and 28 which have been chosen for slicing will be propelled downwards either continually until a food item (such as bread for a sandwich) is no longer beneath the ejection point (where the sliced items will be cast) of revolving slicers 21 and 27, or propelled downwards at will just prior to reaching the exposed blade (and then retracted upwards after passing the blade if desired).

Revolving slicers 21 and 27 can be placed at various angles and run at varying speeds to achieve the desired effect for each specific application. For instance a revolving slicer cutting proteins such as cold cuts may likely want to cast the meat onto the sandwich at an angle (roughly between 20 and 40 degrees, varying with speed of the blade rotations) to lay the meat on the bread in an ‘S’ shape which can make the sandwich more aesthetically pleasing. On the other hand cheeses may be cut relatively flat as they have little flexibility and will work best if placed on top of the sandwich flat. Furthermore, the distance between the conveyor belt and the bottom of the revolving slicer can vary for each application but in most cases it will be less than eight inches of space between the underside of the blade and the food item on the conveyor belt.

It should also be noted that the elevation view of the slicing chambers 211 shows varying shapes and sizes for the chambers such as 22 and 28 and they need not be symmetrical, nor is the invention limited to a set number of chambers such as 22 and 28 per revolving slicer.

In a particular embodiment of the revolving slicer and its chambers such as 22 and 28 may consist of a system of interchangeable parts whereas the slicers may be manufactured with large chambers that can fit most food items with room to spare and product specific chambers may fit inside the larger openings and be fastened in. Therefore, each chamber will have a designated food item for it, and the software will not need to be reprogrammed every time the machine is restocked and will be easily able to keep track of what food is in which slicer chamber such as 22 and 28.

The revolving slicers could be made of several different materials, an aluminum body and mount seems to be the ideal embodiment, with plastic/polymer interchangeable slicer chambers, yet the aforementioned materials are not specific to the invention.

In some embodiments, food products may need to be prepped before they are loaded into the slicing chambers, and a person or machine may need to wash and chop some ingredients to ensure they will fit. For instance, when placing tomatoes in a slicing chamber 22 and 28 one may likely need to cut the top and bottom off of the tomato, removing the stem and simultaneously yielding a flat surface so they will stack nicely on top of one another. Additionally, while the invention will be compatible with standard cold-cuts and proteins after slightly trimming them, in order to make the process more efficient, cold-cuts will be shaped (when they are being made) in a cylindrical fashion to fit the revolving slicer chamber whenever applicable. While it is shown in this figure as having one blade, for some applications numerous blades and cutting edges could be used without straying from the scope of the present invention.

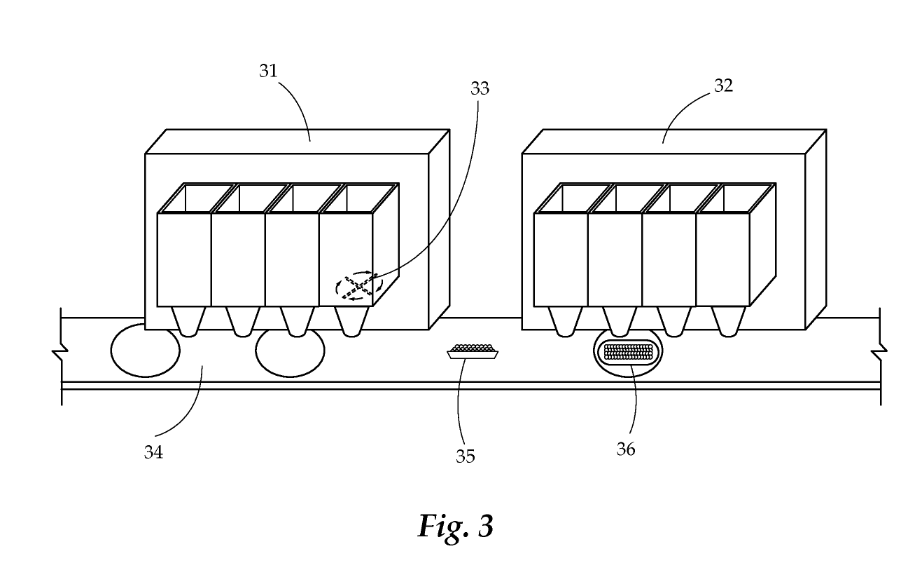

Referring now to FIG. 3, two salsa distributors 31 and 32 are shown. Salsa distributor 31 is shown with an agitator 33 to mix ingredients, the two salsa distributors are shown positioned over a typical assembly line conveyor belt 34, making food items such as a salad bowl 35 and a burrito 36.

In further detail, still referring to the invention of FIG. 3, salsa distributor 31 is a refrigerated unit and salsa distributor 32 is a heated unit. The refrigerated unit is shown as a transparent box around the salsa distributor which is shown with four chambers where food may be loaded into via the top and released via a governor on the bottom. The refrigerated unit may be heavily insulated and equipped with the typical machinery of a refrigerator (compressor, thermostat and etc.) which are not shown for simplicity's sake. The refrigerated salsa distributor 31 may contain menu items that need refrigeration, such as salsa, guacamole, and etc. Each chamber may be fitted with a governor or similar structure on the bottom capable of distributing the ingredients designated for each chamber. In some cases a drain will be needed to separate liquids from solids. The chambers will be fed primarily via gravity, and in some cases an agitator such as a plastic stirrer 33, or a vibration device to loosen material from the walls of the chamber will be used to ensure an even flow of ingredient to the governor at the bottom. Note that the salsa distributor 31, 32 need not have only four chambers and it does not need to be rectangular as depicted in FIG. 3. In most cases it will have a hinged lid on top of the refrigerated unit and an additional hinged lid on top of the chambers inside.

Salsa distributor 32 shows a salsa distributor which may be heated via steam or a number of available heating mechanisms. The heating mechanism is depicted as a transparent rectangle around the salsa distributor. A heated salsa distributor 32 may be useful for distributing ingredients such as beans, rice, chopped or pulled chicken, chopped or pulled steak and etc. The governor will vary based on the ingredients in each chamber. One can see a burrito 36 having hot beans placed on it. Additionally, the salsa distributor may be compatible with the integrated touch screen depicted in FIG. 1 which will be desired in some applications.

Referring now to FIG. 4 a simplified sandwich assembly line placed over a belt driven conveyor belt is provided. Specific components are labeled accordingly: a bread feeder 41, a sauce/condiment dispenser 42, revolving slicer stocked with produce 43, revolving slicer stocked with meats and cheeses 44, blade press to halve sandwiches 45, a sandwich ready to be wrapped 46, a wrapping/bagging station 47. This drawing is meant to give a simplified visual of what a complete sandwich line may look like. Following the steps of making a sandwich, bread could be fed either via machine or by hand to start the process, condiments are applied if they are requested, produce gets sliced onto the sandwich via revolving slicer 43, the desired meats and cheeses are sliced onto the sandwich via revolving slicer 44, a blade press or similar saw halve the sandwich, the sandwich gets bagged or wrapped via a number of different alternatives.

FIG. 5 represents several different ways of propelling and retracting food items through a slicer chamber 51, moving the food towards and away from the blade. The depicted notions include a belt driven track 52 running parallel to the slicer chamber, a spiked or textured wheel capable of rotating in one direction 53, and a spiked or textured wheel which rotates in two directions 54. All of the suggested means of propelling food items towards and away from the blade will be controlled by a motor and/or simple mechanical devices such as a spring. Generally, these structures may be referred to as either a retracting structure if/when used to retract the food items, or a piston if/when used to drive the food items forward. Ultimately the best method will be one which works well with the ingredient in the specific slicer chamber and in many scenarios a different device will be needed in each chamber. It should be understood that most slicer chambers will not have multiple different types of propulsion methods in the same chamber as depicted in FIG. 5, although this will be required in some instances to accurately propel certain ingredients. Ratcheting wheels could be quite useful in propelling the food towards and or away from the slicer blade, for instance a wheel could be set to spin towards the blade but have a ratcheting mechanism built into the belt/wheel so that the gears slip when the electrical motor turning the wheel/belt is fully exerting itself, for instance when the meat is resting on the blade guard and cannot go forward any more until a piece is sliced off. Such a mechanism could prolong the life of the motor which drives the belt/wheel. Such a ratcheting wheel/belt could keep steady pressure on the food item in the slicing chamber without overworking the electrical motor which propels/retracts food towards and away from the blade.

A wheel with a built in drag, that could be adjustable for each food item, may also be useful in several instances, the drag may prevent food from falling towards the blade due to gravity when the slicer is being operated vertically. The ideal embodiment may likely be a chain such as a bicycle chain which runs parallel to the entire slicer chamber on one or both sides, this may allow food specific inserts to be placed inside the slicer chamber and connected to the chain, allowing flexibility in what food inserts can go into each slicer chamber. For instance a slicer chamber insert designed for cucumbers may usually require a smaller circumference than the standard slicer chamber opening, yet the cucumber insert could have gears built into the sides which connect a spiked wheel in the side of the smaller chamber for the cucumber to the chain operating parallel to the slicer chamber which is being driven by an electrical motor, giving additional flexibility to the mechanism which drives the food items towards and or away from the blade.

While not shown in the drawings for simplicity sake, a lid may be placed over each slicer chamber for most applications to prevent the food from falling out while the revolving slicer is revolving. While such a lid will not be necessary in all cases whereas the chamber may revolve slowly or etc. it will be needed in several applications.

Referring now to FIG. 6, another embodiment to propel foods toward and away from the slicer blade is shown. If a flexible membrane 62 which lines the walls of the slicer chamber such as rubber is used, the slicer 61 could use a series of pistons or tightening clamps/wheels to propel food through the slicing chamber 62 in a fashion similar to the human digestive system. Pressure from all sides at a specific point in the chamber is shown by the inwards facing arrows. This pressure may propel the food downwards, assuming there is no food stocked in the area above where the pressure is being applied.

Referring now to FIG. 7, a piston driven means of propelling food towards the blade is provided. Shown in the drawing is the revolving slicer chamber 71, food items 72 loaded into a particular slicer chamber, a housing assembly for the piston motors and controls 73, a piston 74 is shown through a slicer chamber, and slices of a food item projecting from the device 75. Note that this could be used in conjunction with any of the devices depicted in FIG. 5, as well as with other mechanical devices such as a wheel with drag, or a spring loaded wheel to keep food items from moving down involuntarily due to gravity. The pistons 74 and their motors may be seated on top of the slicing chamber 71 in an apparatus which rotates with the slicing chamber and is controlled electronically. Any number of means could be used to drive the pistons and the motor or device which drives it need not be directly on top of the revolving chamber. While multiple pistons are shown, in another embodiment a single piston 74 may be used in multiple chambers 71.

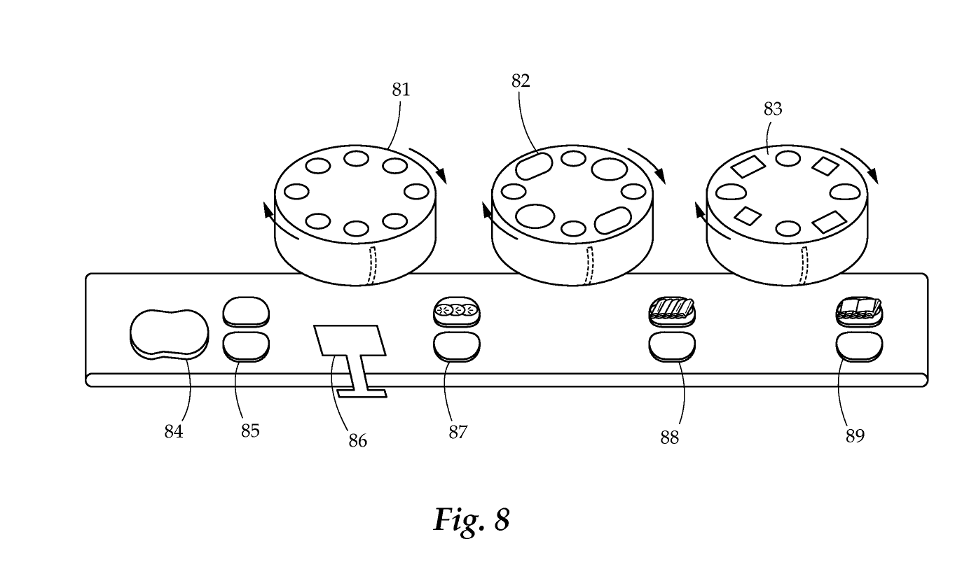

Referring now to FIG. 8, an elevation view of a simple sandwich assembly line utilizing three revolving slicers positioned over a traditional conveyor belt assembly line is depicted. Shown in the drawing are: a revolving slicer stocked with produce 81, a revolving slicer stocked with meat 82, a revolving slicer stocked with cheese 83, a piece of bread near the start of the assembly line 84, a piece of bread with condiments applied to it 85, a guard 86 to help direct the ingredients cast from the revolving slicer onto the bread or food item in an orderly fashion, a sandwich with produce ingredients on it 87, a sandwich with produce and meat on it 88, and finally a sandwich with produce, meat and cheese on it 89. This is a snapshot of an assembly line that may be moving from left to right. Condiments may be applied to the bread 85 in any manner, such as via prior art not depicted in the drawing. Furthermore, not all sandwiches will require condiments as depicted by bread 84. In this embodiment, revolving slicer chamber 81 is positioned so that the area where sliced ingredients will be ejected are centered over the bread moving along the assembly line. In this view, slicers 81, 82, 83, are depicted at a slight angle, with the top tilted slightly to the left, the machines may be adjustable both front to back and left to right to achieve the proper slicing angle required for each application. Revolving slicer rotates clockwise, carrying each slicer chamber past the exposed blade at the bottom of the slicer chamber depicted as a crescent moon shaped dotted line.

Revolving slicer 81 is shown equipped with a guard 86 to help direct the ingredients onto the sandwich. The aforementioned guard 86 could vary in material and design but may sometimes be necessary to help direct ingredients cast from the slicer to fall evenly onto the bread. For instance, shown in FIG. 8 is a sloped guard 86 mounted to the edge of the conveyor belt so it is stationary and the bottom-most part of the guard 86 is lined up with the bread as it passes underneath it. If shredded lettuce were to come out of revolving slicer 81 and hit the guard 86, it may ideally not cling to the guard but fall below onto the sandwich. A sandwich which has just passed under the revolving slicer 81 and is topped with the requested produce is shown as 87.

Revolving slicer chamber 82 similar to revolving slicer except it is stocked with meats. A sandwich 88 is shown which has passed under both revolving slicer 81 and then revolving slicer 82 and is now topped with the requested produce and meat.

Revolving slicer 83 is similar to revolving slicers 81 and 82 except it is stocked with cheese. A sandwich that has passed under revolving slicers 81, 82 and 83 is depicted as 89 having produce, meat and cheese. The design of each slicing chamber varies with each revolving slicer and it could be different for each application. Also note that the number of slicer chambers need not be the same for each revolving slicer produced. Additionally, in this instance each revolving slicer 81, 82, 83 is depicted with one specific family of ingredients such as produce, meat, and cheese. However, the ingredients need not have their own slicer and can be mixed among the chambers of a single slicer or throughout the process.

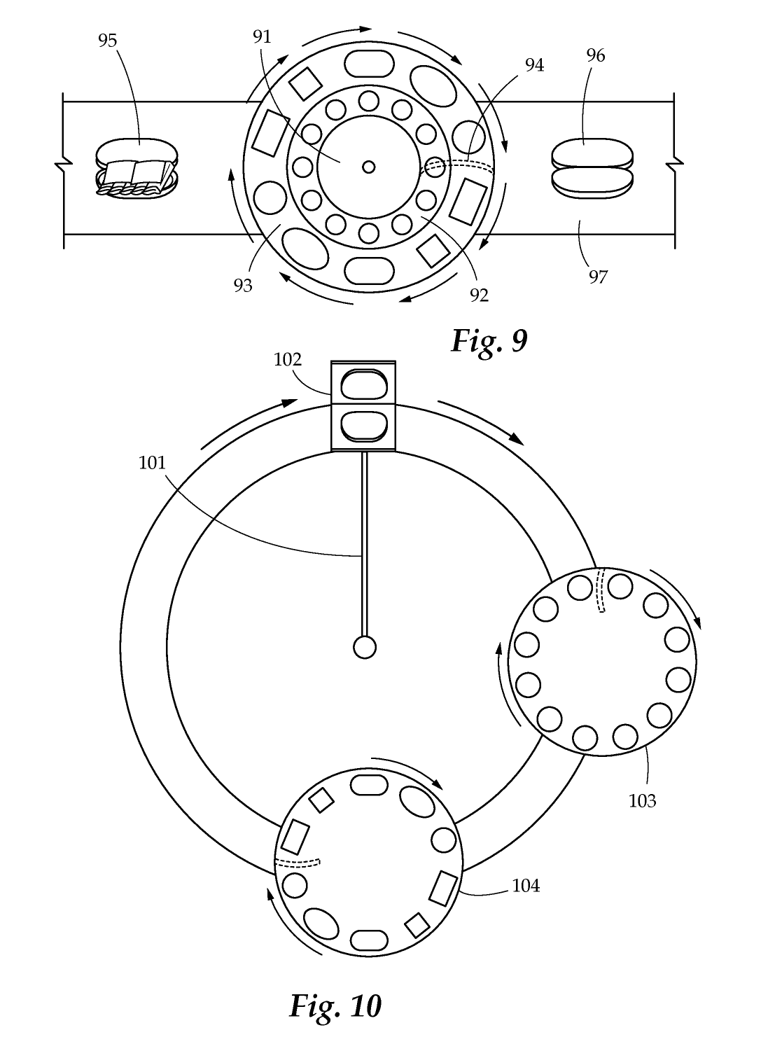

Referring now to FIG. 9, another embodiment of the revolving slicer is shown from an elevation view. Shown in FIG. 9 are a revolving slicer 91 (as shown revolving slicer is set up for clockwise rotation), an internal row of revolving slicer chambers 92, an external row of revolving slicer chambers 93, and the exposed blade area 94 which may cut the food items as they pass. Blade 94 is shown as a dotted line, as it may not be visible from the top of the apparatus unless the revolving slicer apparatus was removed. A finished sandwich 95, bread about to pass under the revolving slicer 96, and a traditional belt driven conveyor belt 97 is also shown.

The embodiment of FIG. 9 is essentially a revolving slicer with two layers of ingredients 92, 93 that may each be sliced as desired as passing over the blade 94. In the drawing, the conveyor belt may move the bread from right to left, the ingredients stored in the outer layer 93 may first be sliced onto the sandwich and then the ingredients in the inner layer 92 may be placed onto the sandwich as the bread passed underneath that area. The two layers of slicer chambers 92 and 93 are depicted as one solid piece of a revolving slicer 91. However, it may be possible to separate the two and even connect them to multiple blades so that each layer had its own blade if so desired. If they were separated, layer 92 could spin independent of layer 93 and vice versa. Note that any number of layers such as 92 and 93 can be used but for practical purposes one or a few will likely be the most needed due to the problem of increasing the size of the revolving slicer with each additional layer of slicer chambers.

FIG. 10 shows another embodiment of a sandwich assembly line from an elevation view. The drawing shows: an arm 101 used to hold the bread 102 and move it underneath revolving slicers 103 and 104. The purpose of this embodiment is to illustrate that the assembly line need not be a conventional belt driven assembly line, and the revolving slicers are applicable to assembly lines of various shapes. Shown in the drawing is a circular assembly line having the bread 102 which is movable by a pivoting arm 101 underneath two revolving slicers 103 and 104 to complete the sandwich or other food item. In this example revolving slicer 103 may be stocked with produce and revolving slicer 104 may be stocked with meat, dispersing the respective ingredients onto the bread 102 as it is moved underneath them by the arm 101. This is important for the retail food industry as in many restaurants space is limited so having an adaptable assembly line is a huge plus. Other shapes such as an S shaped assembly line are also feasible and the invention is not limited to the assembly lines shown in the drawings.

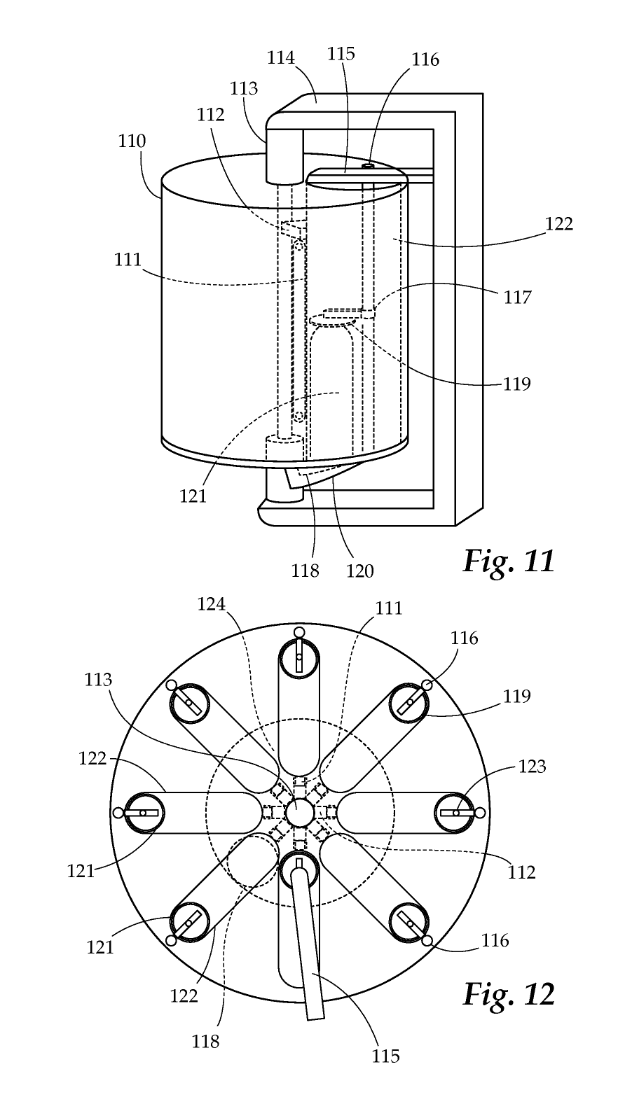

Turning now to FIGS. 11 and 12, still another embodiment of the present invention is provided. In this view, revolving slicer has a barrel 110, and at least one (though likely a plurality of) chambers 122 that have oval shaped cross sections. The blade 118 is held in a housing such that the blade 118 and guide 119 are positioned below a portion of these chambers 122 near a center of the barrel 110, but not all of the chamber. When the food ingredient 121 is at rest, it is positioned on an outside portion of the chamber 122 closer to the exterior of the barrel. When the food ingredient 121 is to be sliced, it is urged radially inward in the chamber 122. Once reaching the wall of the chamber 122 closest to the center, it is urged downward in contact with the blade 118, thus achieving the slicing operation. It should be understood that, in most embodiments, barrel 110 is rotating about drive shaft 113, and held in place by mounting bracket 114 during this movement of food item 121. In some embodiments, gearing or a gear box may be used to allow the barrel to rotate at a rate different from the drive shaft. While only shown in FIG. 11, it should be understood that mounting bracket 114, or similar, may be used in any embodiment of the revolving slicer apparatus to provide support and stability to the revolving slicer.

The food item 121 may be moved inward towards the center of the barrel 110 and downward towards the blade 118 in any manner. In a particular embodiment, as shown, a guide and piston arrangement may be used as a mechanical structure to automatically guide the food item 121 to the blade 118 and release it back to the radial outside of the barrel 110 after slicing. As is best seen in FIG. 12, engagement guide 115 is an angled member which begins at an outside of the barrel attached to mounting bracket 114. Engagement guide 115 is then angled inwardly to a point that is directly above blade 118. A piston 116 is positioned on a shaft within each chamber, the shaft is connected to the food item 121. When a particular food item is to be sliced, the piston 116 of the corresponding chamber is raised. Once raised, it will engage with the engagement guide 115 as the barrel 110 rotates. The guide 115 pushes the piston 116 inward, and brings the food item 121 along with it, causing it to be over the blade when passing the blade rotationally. After passing the blade 118, the piston 116 passes inwardly until it is no longer in contact with the engagement guide 115, and is sprung back by a biasing spring 123 towards an outer perimeter of the barrel 110.

It should be understood that although the blade 118 and blade guard 124 are not rotating with the barrel, there will not be friction between the blade guard 124 and the food items 121 in each chamber 122 because, for example the bottom of the chamber at the outside of the barrel is closed. In another embodiment, the blade guard may have a second rotating portion. This second rotating portion of the blade guard may extend radially beyond the blade to the outer radial edge (or close to) the barrel and may rotate with the barrel 110 while the blade guard 124 remains stationary. This structure may allow the blade guard portion to cover the chambers. As such, the food items in each chamber are resting on the portion of the blade guard rotating with the barrel 110. In this embodiment, as the food item is urged inward towards the blade and center of the barrel, it may slide off the portion of the blade guard rotating with the barrel, to the fixed blade guard 124 and blade 118. Such embodiments may allow a constant downward pressure to be applied on the food in the chamber without the need to retract them upwards. In other embodiments, the food item 121 is elevated by some supporting structure or mechanism.

To achieve a downward urging of the food item 121 towards blade 118, a number of structures may be used, or gravity alone may suffice. In the embodiment shown, a ratcheting mechanism 117 can be slid downward, either automatically or by a forcing structure, as the food item is sliced away. The ratcheting mechanism 117 may provide enough weight to urge the food item 121 downward to the blade. Other structures equivalent to the ratcheting mechanism 117 may be used as well, such as a spring providing a downward pressure. Further, as shown, a gear box 112 may drive a traction belt 111. The traction belt may rotate downward and may engage food item 121 once it contacts the belt.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A revolving slicer for slicing food items comprising:
a barrel, the barrel defining a plurality of chambers that extend lengthwise within the barrel, the barrel rotatable about its major axis, the plurality of chambers configured to receive a food item to be sliced;
a motor in communication with the barrel, configured to rotate the barrel when activated;
a blade guard positioned adjacent to a bottom face of the barrel, at least one of the plurality of chambers being open at the bottom face of the barrel and exposed to the blade guard;
a blade positioned beneath the blade guard, the blade configured to cut the food item within at least one of the plurality of chambers as the barrel rotates above the blade.

2. The revolving slicer for slicing food items of claim 1 further comprising a computerized control system, the computerized control system configured to control at least the motor.

3. The revolving slicer for slicing food items of claim 2 further comprising a touch screen in communication with the computerized control system.

4. The revolving slicer for slicing food items of claim 1 further comprising a conveyor, the conveyor positioned below the blade such that sliced food items fall onto the conveyor.

5. The revolving slicer for slicing food items of claim 1 further comprising a salsa dispenser adjacent to the barrel, the salsa dispenser configured to automatically dispense a flowable or granular food item.

6. The revolving slicer for slicing food items of claim 1 wherein each of the plurality of chambers has an oval shaped cross section, a major axis of the oval extending radially on the revolving barrel, wherein the blade is positioned below a central portion of the chamber, and further comprising:
a guide configured to selectively move the food item within the chamber from a first position in the chamber at a radial outward position of the barrel, to a second position in the chamber at a radial inward position of the barrel, such that when the food item is in the second position and rotates in the chamber over the blade, it is sliced by the blade, and wherein when in the first position the food item is prevented from being sliced by the blade.

7. The revolving slicer for slicing food items of claim 1 wherein the blade guard and the blade are stationary, and wherein the revolving barrel rotates with respect to the blade guard and blade.

8. The revolving slicer for slicing food items of claim 2 wherein the blade is positioned to slice a food item passing through each of the plurality of chambers, one chamber at a time, when the one of the plurality of chambers passes the blade during the rotation of the barrel, and wherein the computerized controller is further configured to selectively control a slicing by the blade of the food item in at least one of the plurality of chambers.

9. The revolving slicer for slicing food items of claim 1 wherein the blade guard is adjustable to control a thickness of a slice by adjusting a distance between it and the blade.

10. The revolving slicer for slicing food items of claim 2 further comprising a sensor in communication with the computerized system, the sensor configured to track a number of slices cut from each of the plurality of chambers.

11. The revolving slicer for slicing food items of claim 4 wherein the barrel has a bottom face angled relative to the conveyor.

12. The revolving slicer for slicing food items of claim 1 further comprising a retracting structure within at least one of the plurality of chambers, the retracting structure configured to draw the food item within the chamber away from the bottom opening of the chamber.

13. The revolving slicer for slicing food items of claim 1 further comprising a piston configured to urge the food item towards the bottom opening of the chamber.

14. A food preparation system comprising:
a revolving slicer comprising:
a barrel, the barrel defining a plurality of chambers that extend lengthwise within the barrel, the barrel rotatable about its major axis, the plurality of chambers configured to receive a food item to be sliced;
a motor in communication with the barrel, configured to rotate the barrel when activated;
a blade guard positioned adjacent a bottom face of the barrel, at least one of the plurality of chambers being open at the bottom face of the barrel and exposed to the blade guard;
a blade positioned beneath the blade guard, the blade configured to cut the food item within at least one of the plurality of chambers as the barrel rotates above the blade;
a first food item in one of the plurality of chambers;
a second food item in a second of the plurality of chambers;
a conveyor, the conveyor positioned below the blade such that sliced food items fall onto the conveyor;
a computerized control system, the computerized control system comprising a user input configured to receive an input from a user, the computerized control system configured to control the motor and the conveyor based on the user input.

15. The food preparation system of claim 14 further comprising a food base positioned on the conveyor, the computerized controller configured to move the conveyor such that the food base is positioned to receive at least one of a sliced first food item and sliced second food item, the food base being one of a slice of bread, a tortilla, a bowl, a plate, a pizza dough, and a roll.

16. The food preparation system of claim 14 wherein the user input of the computerized control system further comprises a touch screen configured to receive the user input instructing the operation of the food preparation system.

17. The food preparation system of claim 14 further comprising a sensor in communication with the computerized system, the sensor configured to track a number of slices cut from each of the plurality of chambers, the computer controller configured to control the conveyor based at least partially on an input from the sensor.

18. The food preparation system of claim 14 further comprising a retracting structure within at least one of the plurality of chambers, the retracting structure configured to draw the food item within the chamber away from the bottom opening of the chamber.

19. The food preparation system of claim 14 further comprising a piston configured to urge the food item towards the bottom opening of the chamber.

20. The food preparation system of claim 14 wherein each of the plurality of chambers has an oval shaped cross section, a major axis of the oval extending radially on the revolving barrel, wherein the blade is positioned below a central portion of the chamber, and further comprising:
a guide configured to selectively move the food item within the chamber from a first position in the chamber at a radial outward position of the barrel, to a second position in the chamber at a radial inward position of the barrel, such that when the food item is in the second position and rotates in the chamber over the blade, it is sliced by the blade, and wherein when in the first position the food item is prevented from slicing by the blade.
